(19) United States
(12) Patent Application Publication
(10) Pub. No.: US 2015/0282910 A1
(43) Pub. Date: Oct. 8, 2015

(54) ORAL HYGIENE DEVICE

(71) Applicant: Dr. Elena G. Furdui-Carr, (US)

(72) Inventor: Elena G. Furdui-Carr, APO, AE (US)

(21) Appl. No.: 14/741,990

(22) Filed: Jun. 17, 2015

(51) Int. Cl. A61C 17/22; A46B 9/04

(52) U.S. Cl. CPC A61C 17/228; A46B 9/045

(57) ABSTRACT

An oral hygiene device includes a mouthpiece defining an arcuate channel, a plurality of sets of bristles disposed within the arcuate channel, and one or more motor modules coupled to the sets of bristles. When the one or more motor modules are activated, they cause the sets of bristles to oscillate or rotate.

### TECHNICAL FIELD

This disclosure relates to oral hygiene devices, such as electric toothbrushes.

### BACKGROUND

A toothbrush is an oral hygiene device or instrument used to clean the teeth and gums. In general, a toothbrush includes one or more sets of bristles mounted to a handle. To use a toothbrush, a user grasps the handle, and sweeps the bristles against his teeth and/or gums in a repetitive motion. In some cases, a toothbrush can include one or more electrically powered motors that oscillate the sets of bristles (e.g., in a circular motion).

### SUMMARY

This disclosure describes oral hygiene devices, such as electric toothbrushes.

An example oral hygiene device includes a mouthpiece and several sets of bristles positioned along the mouthpiece. A user positions the oral hygiene device such that the sets of bristles are in contact with one or more of a person's teeth, and activates the oral hygiene device, causing the sets of bristles oscillate and/or rotate against the person's teeth. In some instances, the sets of bristles can be positioned against multiple teeth simultaneously (e.g., some or all of the teeth on a person's upper or lower jaw), such that several teeth are brushed by the sets of bristles at once. This can be beneficial, for example, as it allows the oral hygiene device to brush multiple teeth more quickly than if each tooth is brushed individually. This also can be beneficial, for example, as it reduces the number of times that the oral hygiene device needs to be repositioned to access each of a person's teeth. Thus, the oral hygiene device can be more convenient and/or less physically taxing to use.

In general, in an aspect, an oral hygiene device includes a mouthpiece defining an arcuate channel, a plurality of sets of bristles disposed within the arcuate channel, and one or more motor modules coupled to the sets of bristles. When the one or more motor modules are activated, they cause the sets of bristles to oscillate or rotate.

Implementations of this aspect may include or more of the following features.

In some implementations, the arcuate channel can be shaped and sized to simultaneously surround a plurality of teeth of a person. The arcuate channel can be shaped and sized to surround all visible surfaces of teeth along an upper or lower jaw of a person.

In some implementations, the mouthpiece can include a first arcuate wall, a second arcuate wall, and a linking portion disposed between and connecting the first and second walls. The first wall, the second wall, and the linking portion can define the arcuate channel. A plurality of sets of bristles can be disposed on each of the first and second walls and on a surface of the linking portion.

In some implementations, the sets of bristles can be distributed along a length of the arcuate channel.

In some implementations, the oral hygiene device can further include a handle extending from a central portion of the mouthpiece in a direction away from the arcuate channel. The oral hygiene device can also include a user input interface disposed on the handle, where the user input interface is configured to receive a user input and cause an operation of the one or more motor modules based on the received user input. The user input interface can include a button, where the user input interface is configured to cause the one or more motor modules to oscillate or rotate the sets of bristles in response to the button being pressed a first time. The user input interface can be configured to cause the one or more motor modules to discontinue oscillating or rotating the sets of bristles in response to the button being pressed a second time.

In some implementations, each set of bristles can include a respective plurality of bristles arranged in a circular pattern.

In some implementations, the mouthpiece can have one or more apertures between an exterior surface of the mouthpiece and the arcuate channel.

In some implementations, at least one aperture can include a slot or hole.

The details of one or more implementations are set forth in the accompanying drawings and the description below. Other aspects, features and advantages will be apparent from the detailed description, the accompanying drawings, and from the claims.

### BRIEF DESCRIPTION OF DRAWINGS

FIG. 1A is a perspective view of an example oral hygiene device.

FIG. 1B is a top view of the oral hygiene device shown in FIG. 1A.

FIG. 1C is a bottom view of the oral hygiene device shown in FIG. 1A.

FIGS. 1D and 1E are side views of the oral hygiene device shown in FIG. 1A.

FIG. 1F is a front view of the oral hygiene device shown in FIG. 1A.

FIG. 1G is a rear view of the oral hygiene device shown in FIG. 1A.

FIG. 2 is a schematic diagram of an example oral hygiene device.

FIG. 3 is a schematic diagram of a drive module coupled to several sets of bristles.

FIG. 4 is a perspective view of another example oral hygiene device.

### DETAILED DESCRIPTION

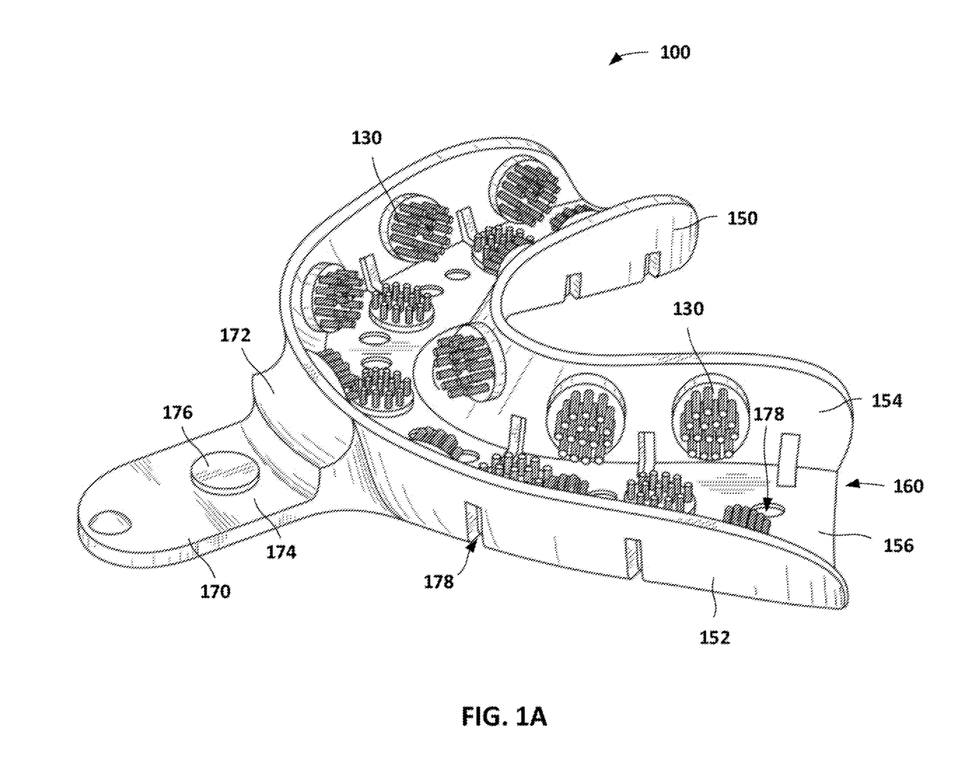

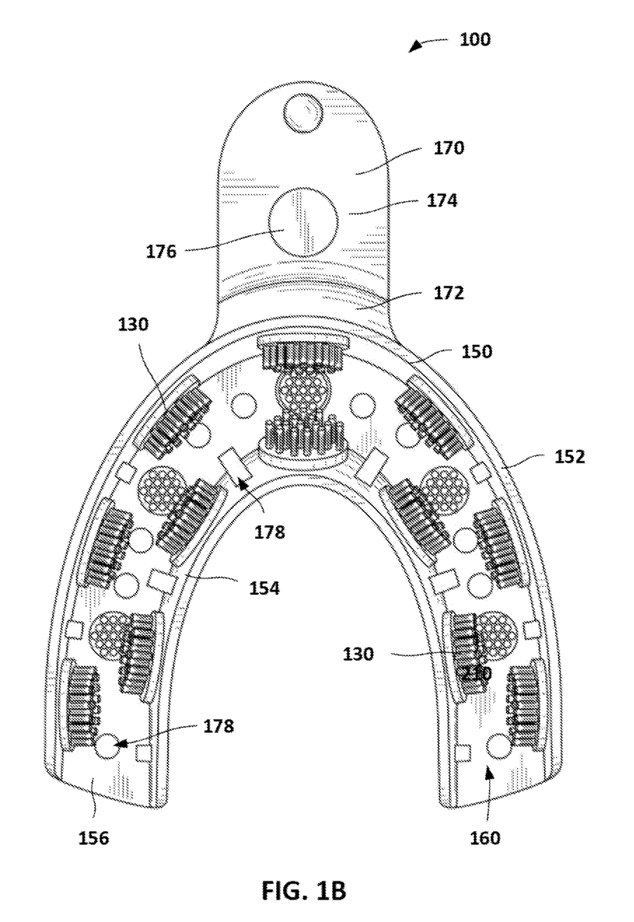

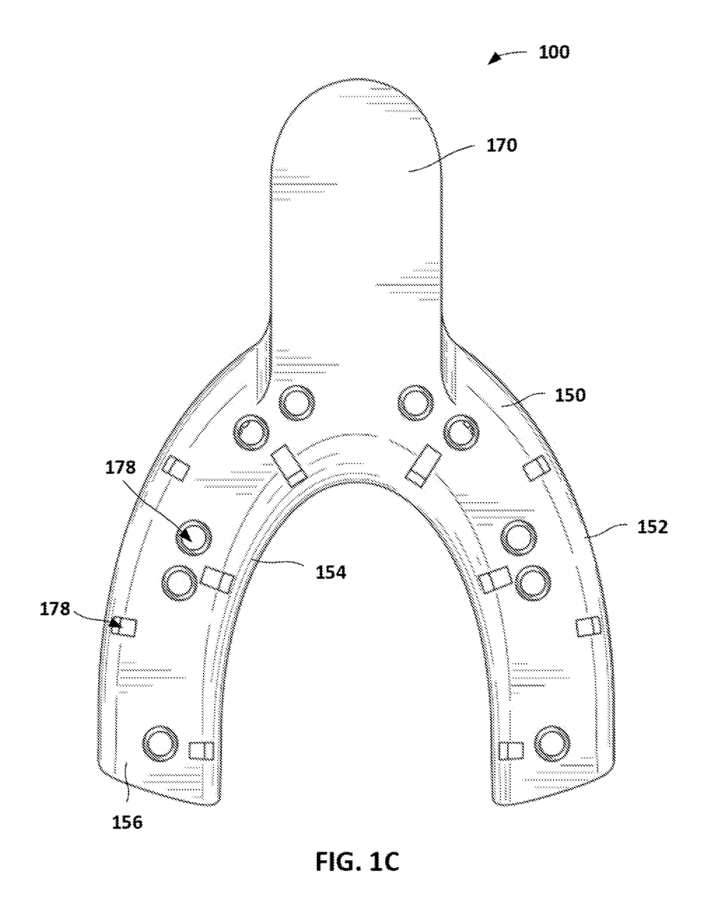

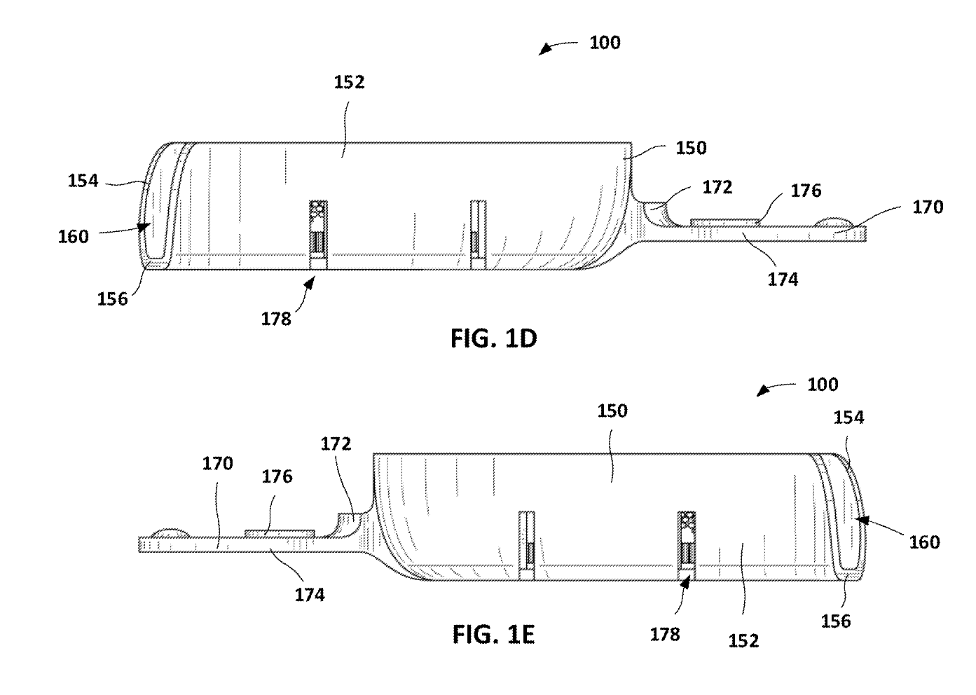

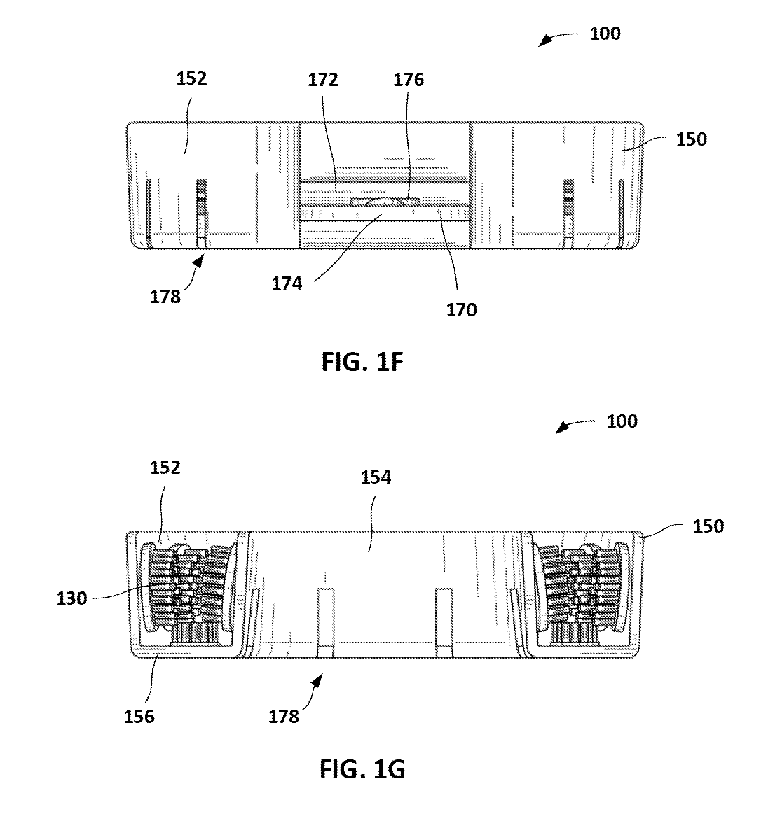

An example oral hygiene device 100 having a mouthpiece 150 is shown in FIGS. 1A-G. In an example usage of the oral hygiene device 100, a user positions the oral hygiene device 100 such that multiple sets of bristles 130 are in contact with one or more of a person's teeth (e.g., one or more of his own teeth or one or more teeth of another person). When the user activates the oral hygiene device 100 the sets of bristles 130 oscillate and/or rotate against the person's teeth. In some cases, a user can apply a dentifrice (e.g., toothpaste, tooth powder, tooth soap, or tooth polish) onto the sets of bristles 130, such that the dentifrice brushes against the teeth during use of the oral hygiene device 100.

In some instances, the sets of bristles 130 can be positioned against multiple teeth simultaneously (e.g., some or all of the teeth on a person's upper or lower jaw), such that several teeth are brushed by the sets of bristles 130 at once. This can be beneficial, for example, as it allows the oral hygiene device 100 to brush multiple teeth more quickly than if each tooth is brushed individually. This also can be beneficial, for example, as it reduces the number of times that the oral hygiene device needs to be repositioned to access each of a person's teeth. Thus, the oral hygiene device 100 can be more convenient and/or less physically taxing to use.

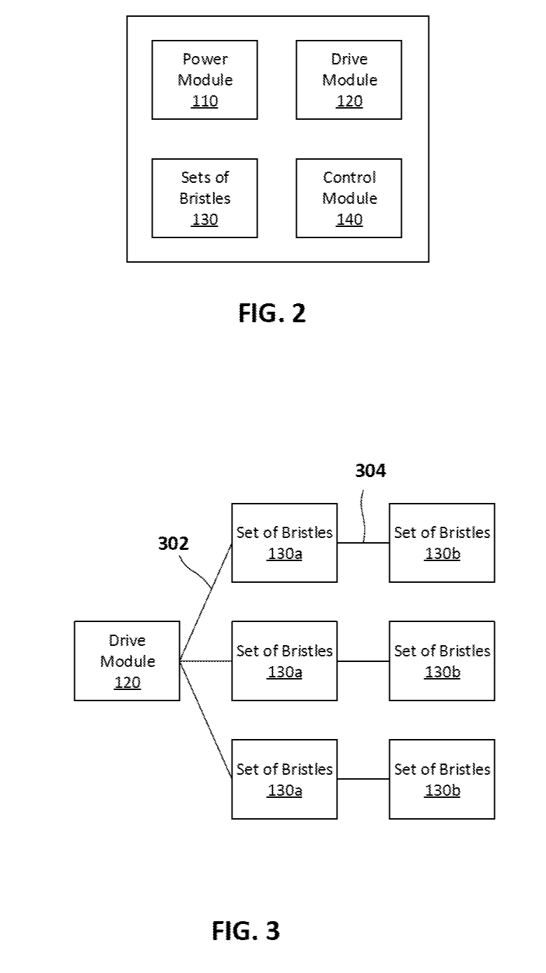

As shown in FIGS. 1A-G, the mouthpiece 150 includes an outer wall 152, an inner wall 154, and a linking portion 156 connecting the outer wall 152 and the inner wall 154. The outer wall 152, the inner wall 154, and the linking portion 156 define a channel 160. When the oral hygiene device 100 is positioned within a person's mouth, the person's teeth (e.g., some or all of the teeth on the person's upper or lower jaw) are disposed within the channel 160, such that the outer wall 152, inner wall 154, and the linking portion 156 are positioned in proximity to, and laterally surround, the person's teeth. As shown in FIG. 2G, the ends of the channel 160 are open.

The outer wall 152 and the inner wall 154 are sized and shaped to correspond to a person's upper or lower set of teeth. For example, the outer wall 152 and inner wall 154 can have an arcuate shape, and can be curved such that their curvature corresponds to the curved arrangement of a person's teeth along her jaw. In some cases, the outer wall 152, the inner wall 154, and the linking portion 156 have a size and shape such that they at surround most, or even all, of a person's teeth along her upper or lower jaw. A tooth can be considered surrounded, for example, if the visible portions of the tooth (e.g., the portions of the tooth above the gingival line, such as the crown) are positioned within the channel 160. Non-visible portions of the tooth (e.g., the portions of the tooth below the gingival line, such as the roots) need not be positioned within the channel 160.

In some cases, the channel 160 can be larger than the person's teeth, such that when the oral hygiene device 100 is positioned within a person's mouth, the oral hygiene device 100 can be moved laterally with respect to the person's teeth. For example, a user can position the oral hygiene device 100 such that a person's teeth are within the channel 160, then move the oral hygiene device 100 laterally (e.g., forwards, backwards, left, and/or right). This can be beneficial, for example, as it allows the user to make small adjustments to the position of the oral hygiene device 100, and allows the oral hygiene device 100 to reach portions of teeth that might otherwise be difficult to access (e.g., the portions of the dentition that are substantially arched and/or positioned between sets of bristles). In some cases, the channel 160 can be shaped and sized such that when the oral hygiene device is positioned within a person's mouth, the oral hygiene device can be moved laterally approximately 5-7 mm with respect to the person's teeth.

The mouthpiece 150 can be made of various materials. For example, in some cases, mouthpiece 150 can be made of plastic, metal, rubber, silicone, or combinations thereof.

As shown in FIGS. 1A-G, the oral hygiene device 100 includes several sets of bristles 130 positioned on the inner surface of the outer wall 152, the inner surface of the inner wall 154, and the surface of the linking portion 156. The sets of bristles 130 extend toward the channel 160, such that when the mouthpiece is 150 is positioned within a person's mouth, the sets of bristles 130 contact the surfaces of the person's teeth (e.g., the visible surfaces of the person's teeth, such as the crowns of the teeth above the gingival line). Thus, the oral hygiene device 100 is activated, the sets of bristles 130 oscillate or rotate to brush several of the person's teeth simultaneously. In some cases, the sets of bristles 130 can be coupled to a drive module 120 that, when activated, oscillate or rotate the sets of bristles 130.

Each set of bristles 130 can have the same size and shape, or a different size and/or shape. For example, as shown in FIGS. 1A-B, in some cases, each set of bristles 130 can have a generally circular shape but can differ in size (e.g., having a different circular radius and/or different brush length). This can be useful, for example, such that the sets of bristle 130 more closely conform to the shape of a user's jaw and the location of her teeth. Although example sets of bristles 130 are shown, this is merely an illustrative example. In practice, sets of bristles 130 can have any shape (e.g., rectangle, oval, polyhedral, or any other shape) and size, depending on the implementation.

The sets of bristles 130 can be distributed along the length of the channel 160, such that they can contact some or all of the teeth positioned within the channel 160. For example, in some cases, several sets of bristles (e.g., three, four, five, six, seven, or more sets of bristles) can be distributed along the length of the outer wall 152. Likewise, in some cases, several sets of bristles (e.g., three, four, five, six, seven, or more sets of bristles) can be distributed along the length of the inner wall 154. Similarly, in some cases, several sets of bristles (e.g., three, four, five, six, seven, or more sets of bristles) can be distributed along the length of the linking portion 156. In some cases, the sets of bristles can be evenly spaced along the outer wall 152, inner wall 154, and/or linking portion 156. In some cases, the sets of bristles 130 can be spaced non-uniformly along the outer wall 152, inner wall 154, and/or linking portion 156 (e.g., such that some adjacent sets of bristles 130 are closer to each other than others).

In some cases, the mouthpiece 150 includes a handle 170 that allows a user to grasp the mouthpiece 150 during use. For example, as shown in FIGS. 1A-F, the mouthpiece 150 can include a handle 170 that extends from a central portion of the outer wall 152 in a direction away from the channel 160. Thus, when the mouthpiece 150 is positioned into a person's mouth, the handle 170 extends outside the person's mouth such that it can be grasped by a user.

The handle 170 can also house one or more of the components of the oral hygiene device 100. For example, the handle 170 can house a power module 110, a drive module 120, and/or a control module 140. As an example, the handle 170 can include a first compartment 172 for housing one or more drive modules 120, and a second compartment 174 for housing the power module 110 and the control module 140. A portion of the control module 140 (e.g., a button or other user interface element) can be positioned above the compartment 174 and the power module 110, such that it can be accessed by the user. For example, a button 176 can be positioned above the compartment 174 and the power module 110, such that a user can press the button 176 to input commands into the oral hygiene device 100 (e.g., to turn the drive modules 120 one or off). In some cases, the button 176 can be removed or opened in order to reveal the compartment 174 (e.g., to facilitate removal and replacement of a battery).

In some cases, the mouthpiece 150 defines one or more apertures through the outer wall 152, the inner wall 154, and/or the linking portion 156. These apertures can be beneficial, for example, to facilitate drainage from the mouthpiece 150 (e.g., to allow saliva, toothpaste, water, or particulate matter to drain from the channel 160 of the mouthpiece 150). As an example, as shown in FIGS. 1A-G, the mouthpiece 150 can define slot-shaped or circular-shaped apertures 178 along the length of the mouthpiece 150. In some cases, the one or more apertures 178 can extend along an entire height of the outer wall 152 or inner wall 154 (e.g., from the bottom to the top of the outer wall 152 or inner wall 154), or along a portion of the height of the outer wall 152 or inner wall 154 (e.g., from the bottom to an intermediate point of the outer wall 152 or inner wall 154). Although a slot-shaped and circular-shaped apertures are shown, these are merely illustrate examples. In practice, the mouthpiece 150 can include apertures having other shapes (e.g., square, oval, elliptical, or other shapes), or no apertures at all, depending on the implementation.

A schematic diagram of an example oral hygiene device 100 is shown in FIG. 2A. The oral hygiene device 100 includes a power module 110, a drive module 120, sets of bristles 130, and a control module 140.

The power module 110 provides electric energy to the oral hygiene device 100. The power module 110 can provide electric energy in a variety of ways, depending on the implementation. For instance, in some cases, the power module 110 can include an electric battery that converts stored chemical energy (e.g., energy contained within one or more electrochemical cells) into electrical energy. As examples, the power module 110 can include one or more alkaline batteries, nickel-metal hydride batteries, lithium ion batteries, lithium polymer batteries, nickel cadmium batteries, or any other suitable type of battery. In some cases, the power module 110 can include one or more “coin” and “buttons” batteries (e.g., a batteries having a coin-like, button-like, or disc-like shape). As an example, in some cases, the power module 110 can include one more coin batteries such as a CR2032 3V lithium-manganese dioxide battery. In some cases, the battery can be readily removed and replaced with a new battery.

In some cases, the power module 110 can provide electric energy, at least in part, by obtaining electric energy from an outside source. For instance, in some cases, the power module 110 can be coupled to an external electric source (e.g., a household electrical system, external generator, or other external power source) and convert electrical energy obtained from the external electric source for use by the oral hygiene device 100. As an example, the power module 110 can include one or more voltage converters (e.g., direct current (DC) convertors, alternating current (AC) converters, AD-to-DC converters, or DC-to-AC converters) in order to provide electrical energy at a voltage, current, and frequency that can be readily used by the other components of the oral hygiene device 100.

In some cases, the power module 110 includes modules to recharge one or more of the batteries contained within the oral hygiene device 100. For example, in some cases, the power module 110 can include a connection port that allows a user to connect a conductive cable coupled to an external source of electric energy. Electric energy received from this external source can then be used to recharge the batteries. As another example, in some cases, the power module 110 can include an inductive charging elements that allows a user to place the oral hygiene device 100 in proximity with an inductive power transmitter. Electric energy received from this inductive power transmitter can then be used to recharge the batteries.

Although FIG. 2 shows an oral hygiene device 100 having a single power module 110, in practice, an oral hygiene device 100 can have any number of power modules 110 (e.g., one, two, three, four, or more), depending on the implementation.

The drive module 120 converts electric energy into mechanical energy (e.g., movement). As an example, the drive module 120 can include one or more electric motors. When electric energy (e.g., from the power module 110) is applied to the drive module 120, the drive module 120 applies an oscillatory and/or rotational force to the sets of bristles 130, such that the sets of bristles or rotated and/or oscillated.

In general, the drive module 120 is mechanically coupled to one or more of the sets of bristles 130, such that mechanical energy from the drive module 120 is transferred to the sets of bristle 130. As shown in FIG. 3, in some cases, the drive module 120 can be directly coupled to one or more sets of bristles 130a (e.g., through one or more flexible drive shafts or cables 302), such that the drive module 120 directly applies an oscillatory and/or rotational force to these sets of bristles 130a. These sets of bristles 130a can be coupled to additional sets of bristles 130b (e.g., through additional drive shafts or cables 304), such that the oscillatory and/or rotational force is likewise applied to the additional sets of bristles 130b. In this manner, the drive module 120 can be directly coupled to a subset of the sets of bristles 130a, and indirectly coupled to other sets of bristles 130b. In some implementations, the drive module 120 can be directly coupled to a first set of bristles 130 on the outer wall 152, a second set of bristles 130 on the inner wall 154, and a third set of bristles on the linking portion 156. In turn, the first, second, and third sets of bristles 130 can each be coupled to other sets of bristles on the outer wall 152, inner wall 154, and linking portion 156, respectively.

In some cases, the drive module 120 generates force in a continuous manner. For example, in some implementations, when the drive module 120 is active, the drive module 120 can continuously oscillate and/or rotate the sets of bristles 130. In some cases, the drive module 120 can generate force in a periodic manner. For example, in some implementations, when the drive module 120 is active, the drive module 120 can periodically oscillate or rotate the sets of bristles 130 according to a particular pattern (e.g., according to a particular angular velocity and duty cycle). In some cases, the drive module 120 generates force according to other patterns (e.g., according to a particular pulse rate), or in some cases, irregularly without a particular pattern (e.g., randomly). In some cases, the operation of the drive module 120 can be controlled by the user (e.g., selectively turned on and off, or selectively switched between different patterns of operation).

Although FIG. 2 shows an oral hygiene device 100 having a single drive module 120, in practice, an oral hygiene device 100 can have any number of drive modules 120 (e.g., one, two, three, four, or more), depending on the implementation.

Each set of bristles 130 includes a set of tightly clustered bristles (e.g., fiber-like or hair-like structures). When the sets of bristles 130 are applied against a person's teeth and oscillated or rotated by the drive module 120, the sets of bristles 130 brush against the surfaces of a person's teeth. This facilitates the cleansing of a person's teeth and/or gums. In general, each set of bristles 130 can include bristles having different stiffness, textures, sizes, and forms. Bristles can be made of various materials. For example, in some cases, bristles can be made of nylon or other synthetic fibers.

Each set of bristles 130 can be arranged into a particular pattern. For example, in some cases, a set of bristles can be arranged in a generally circular pattern. Other patterns are also possible (e.g., rectangular, ovular, polyhedral, or any other pattern).

The control module 140 controls the operation of the oral hygiene device 100. In some implementations, the control module 140 allows the user to input commands in order to control the operation of the oral hygiene device 100. As an example, in some cases, the user can input commands to switch the oral hygiene device 100 on or off, adjust the speed of operation of the drive module 120, or adjust a pattern of movement by the drive module 120.

In some implementations, the control module 160 can include one or more input elements such as buttons, switches, or dials that allow the user to select between several different commands. In some cases, the control module 140 includes separate user input elements (e.g., separate buttons) for each individual command. In some cases, the user can repeatedly press a single button to switch the oral hygiene device 100 between multiple different operating states. As an example, in some implementations, a user can press a button to switch the device from a power off state to a low operating state (e.g., a state in which the drive module 120 rotates sets of bristles 130 relatively slowly). The user can press the button again to switch the device to a medium operating state (e.g., a state in which the drive module 120 rotates the sets of bristles more quickly), press the button again to switch the device to a high operating state (e.g., a state in which the drive module 120 rotates sets of bristles more quickly still), and press the button again to switch the device back to the power off state.

In some cases, the sets of bristles 130 can be positioned on a mouthpiece that is shaped and sized to at least partially surround multiple teeth of a person. The sets of bristles 130 can be positioned such that they face towards the person's teeth when the mouthpiece is positioned within a person's mouth. Thus, the sets of bristles can be positioned against multiple teeth simultaneously (e.g., some or all of the teeth on a person's upper or lower jaw), such that several teeth are brushed by the sets of bristles 130 at once.

### Advantages

Implementations of the oral hygiene device can provide one or more of the following benefits.

As described above, during use of the oral hygiene device, multiple sets of bristles can be positioned against multiple teeth simultaneously (e.g., against some or all of the teeth on a person's upper or lower jaw), such that several teeth are brushed by the sets of bristles at once. This can be beneficial, for example, as it allows the oral hygiene device to brush multiple teeth more quickly than if each tooth is brushed individually. This also can be beneficial, for example, as it reduces the number of times that the oral hygiene device needs to be repositioned to access each of a person's teeth. Thus, the oral hygiene device can reduce the amount of time needed to brush a person's teeth.

The oral hygiene device can also simplify the process of brushing teeth. For example, when the oral hygiene device is positioned in a person's mouth, the sets of bristles are positioned against the person's teeth in an arrangement that facilitates effective cleaning of the teeth. As such, the effectiveness of the tooth brushing process becomes less dependent on a user's brushing technique and physical dexterity. This can be beneficial, for example, for young children, elderly individuals, disabled individuals, or other users who lack the knowledge and/or physical ability to properly brush their teeth using traditional toothbrushes.

The oral hygiene device can be beneficial for users of all age groups, from children to elderly, including persons with disabilities and individuals with poor hand movement coordination

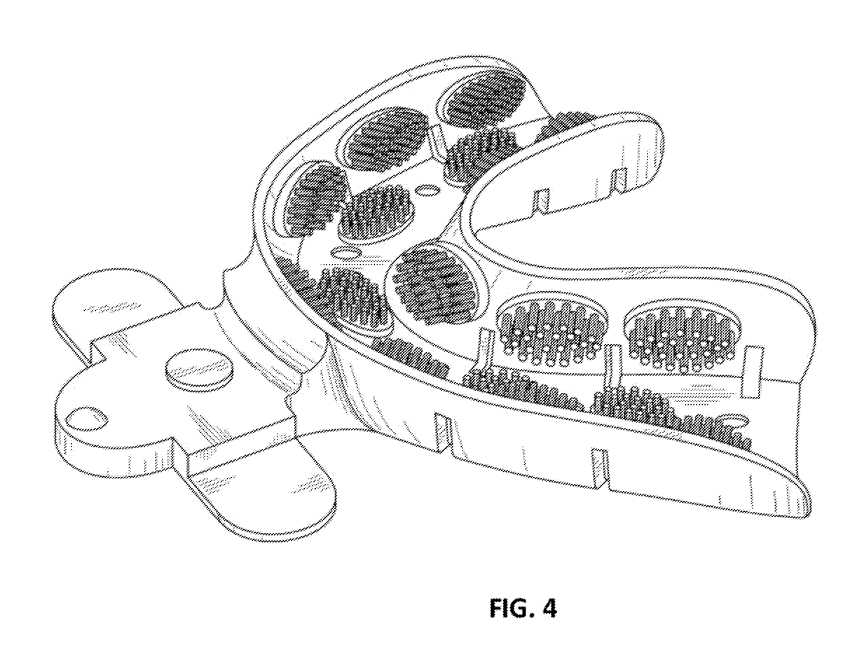

A number of implementations have been described. Nevertheless, it will be understood that various modifications may be made without departing from the spirit and scope of the disclosure. For instance, in some implementations, portions of the oral hygiene device can be modified to have different shapes and/or dimensions. As an example, FIG. 4 shows an oral hygiene device 400. The oral hygiene device 400 is similar to the oral hygiene device 100 shown in FIGS. 1A-G. For example, the oral hygiene device 400 includes a mouthpiece 150 and multiple sets of bristles 130 positioned within a channel 160 of the mouthpiece 150. However, in this example, the oral hygiene device 400 includes a cross-shaped handle 170. In some cases, this cross-shape can be beneficial as it allows a user to more easily grasp and manipulate the oral hygiene device 400. The oral hygiene device 400 also includes sets of bristles 130 having an ovular shape. In some cases, this ovular shape can be beneficial as it allows the sets of bristles 130 to contact a greater number of teeth along a particular direction (e.g., along a person's jawline).

Accordingly, other implementations are within the scope of the following claims.

What is claimed is:

1. An oral hygiene device comprising:
a mouthpiece defining an arcuate channel;
a plurality of sets of bristles disposed within the arcuate channel; and
one or more motor modules coupled to the sets of bristles, wherein when the one or more motor modules are activated, they cause the sets of bristles to oscillate or rotate.

2. The oral hygiene device of claim 1, wherein the arcuate channel is shaped and sized to simultaneously surround a plurality of teeth of a person.

3. The oral hygiene device of claim 1, wherein the arcuate channel is shaped and sized to surround all visible surfaces of teeth along an upper or lower jaw of a person.

4. The oral hygiene device of claim 1, wherein the mouthpiece comprises a first arcuate wall, a second arcuate wall, and a linking portion disposed between and connecting the first and second walls, wherein the first wall, the second wall, and the linking portion define the arcuate channel.

5. The oral hygiene device of claim 4, wherein a plurality of sets of bristles are disposed on each of the first and second walls and on a surface of the linking portion.

6. The oral hygiene device of claim 1, wherein the sets of bristles are distributed along a length of the arcuate channel.

7. The oral hygiene device of claim 1, further comprising a handle extending from a central portion of the mouthpiece in a direction away from the arcuate channel.

8. The oral hygiene device of claim 7, further comprising a user input interface disposed on the handle, wherein the user input interface is configured to receive a user input and cause an operation of the one or more motor modules based on the received user input.

9. The oral hygiene device of claim 8, wherein the user input interface comprises a button, wherein the user input interface is configured to cause the one or more motor modules to oscillate or rotate the sets of bristles in response to the button being pressed a first time.

10. The oral hygiene device of claim 9, wherein the user input interface is configured to cause the one or more motor modules to discontinue oscillating or rotating the sets of bristles in response to the button being pressed a second time.

11. The oral hygiene device of claim 1, wherein each set of bristles comprises a respective plurality of bristles arranged in a circular pattern.

12. The oral hygiene device of claim 1, wherein the mouthpiece has one or more apertures between an exterior surface of the mouthpiece and the arcuate channel.

13. The oral hygiene device of claim 1, wherein at least one aperture comprises a slot or hole.
